(19) United States
(12) Patent Application Publication
(10) Pub. No.: US 2003/0080086 A1
(43) Pub. Date: May 1, 2003

(54) Manufacturing fiber arrays

(76) Inventors: David Volfson, Worcester, MA (US); Geoffrey Kaiser, Groton, MA (US); Patrick Tan, Wellesley, MA (US); John S. Berg, Franklin, MA (US)

Correspondence Address: FISH & RICHARDSON PC, 225 FRANKLIN ST, BOSTON, MA, 02110, US

(21) Appl. No.: 10/222,119

(22) Filed: Aug. 16, 2002

Related U.S. Application Data
(60) Provisional application No. 60/313,155, filed on Aug. 17, 2001.

(51) Int. Cl. B29D 11/00

(52) U.S. Cl. 216/24

(57) ABSTRACT

A method of forming fiber arrays includes using a base substrate to form an alignment pattern, holding a fiber fixed with reference to the pattern, and, while the fiber is held fixed, bonding a cap to the fiber, the cap being of a material having a different coefficient of thermal expansion than the base substrate. The base substrate can be an etched silicon chip and the cap can be of a fused silicon material. The method provides one and two dimensional arrays of fibers, the fiber aligning structures of the arrays having coefficients of thermal expansion selected to match those of connecting components. A fiber array made by the method includes a pair of substrates, a fiber sandwiched between the substrates, and a molded material holding the fiber in a predetermined alignment with respect to a pattern preformed in the molded material.

### CLAIM OF PRIORITY

This application claims priority under 35 USC §119(e) to U.S. Patent Application Serial No. 60/313,155, filed on Aug. 17, 2001, the entire contents of which are hereby incorporated by reference.

### TECHNICAL FIELD

This invention relates to manufacturing fiber arrays.

### BACKGROUND

Current methods of manufacturing fiber arrays generally include placing fibers into grooves that have been formed in a substrate and then bonding the fibers within the grooves with adhesive. The grooves in the substrate properly align and space the fibers. Such grooves can be made with high precision, typically by photolithography followed by anisotropic etch of silicon taking advantage of preferential etch rates of silicon on different crystallographic planes. Using such chips, fibers can be assembled to sub-micron accuracy. Typically, the silicon workpiece has a higher coefficient of thermal expansion (“CTE”) than that of other components in optical/mechanical assemblies.

An alternative method of manufacturing grooves on chips for fiber placement/alignment involves mechanical grinding techniques. For improved alignment, materials, such as glass silica, having a CTE that closely matches that of other optical components can be selected.

Yet another technique for manufacturing fiber arrays on chips with compatible CTE, such as silica glass, involves photolithography and isotropic etch of silica glass to form u-shaped grooves. Because masking materials for silica glass are not as robust as the ones used in anisotropic silicon etch, it is more difficult to form a sharp edge that ensures contact between the groove and the fiber in a desired, predetermined fashion.

### SUMMARY

In one aspect, the inventions provide a method including using a base substrate to form an alignment pattern, holding a fiber fixed with reference to the pattern, and while the fiber is held fixed, bonding a cap to the fiber, the cap being of a material having a different coefficient of thermal expansion than the base substrate.

Variations of this aspect of the inventions can include one or more of the following features. The fiber is an optical fiber. The method also includes removing the fiber and the cap as a unit from the pattern. The alignment pattern is formed in the substrate. The alignment pattern is formed in a material by molding the material against the pattern. Two or more fibers are held fixed with reference to the pattern and the cap is bonded to all of the fibers. The pattern includes grooves. The fiber is held fixed with reference to the pattern by contact with the pattern. The method also includes bonding a second cap to the fiber. The second cap forms a receiving pattern arranged to at least roughly correspond to the alignment pattern. The receiving pattern includes trenches. The cap forms a receiving pattern arranged to at least roughly correspond to the alignment pattern. The receiving pattern includes trenches. The method also includes coupling the cap and bonded fiber to another component that has a coefficient of thermal expansion matched to the coefficient of thermal expansion of the cap. The base substrate is of silicon. The alignment pattern is etched in the base substrate. The cap substrate is of fused silica.

In another aspect, the inventions provide a method that includes etching a groove in a base substrate, positioning a fiber at least partially within the groove, placing a first cap substrate adjacent the base substrate such that the fiber is between the base substrate and the cap substrate, and bonding the fiber to the cap substrate.

Variations of this aspect of the inventions may include one or more of the following features. The method further includes separating the first cap substrate from the base substrate with the fiber remaining bonded to the first cap substrate. The method further includes placing a second cap substrate adjacent the first cap substrate with the fiber positioned between the first and the second cap substrates. The method further includes bonding the second cap substrate to the first cap substrate. The method further includes coating the base substrate with a release agent. The base substrate is of silicon. The first cap substrate is of fused silica. The step of etching includes anisotropic etching. The step of etching includes forming grooves in the base substrate. The method further includes positioning fibers such that each is at least partially within one of said grooves in the base substrate. The method further includes bonding each of said plurality of fibers to the first cap substrate. The method further includes separating the cap substrate from the base substrate with the plurality of fibers remaining bonded to the first cap substrate. The method further includes positioning a second plurality of fibers such that each is at least partially within one of said plurality of grooves in the base substrate, placing said first cap substrate with the plurality of fibers adjacent the base substrate such that the second plurality of fibers is between the first cap substrate and the second cap substrate, and

bonding the second plurality of fibers to the first cap substrate. The second plurality of fibers is bonded to the first cap substrate in a position directly adjacent the plurality of fibers. The method further includes separating the first cap substrate from the base substrate with the plurality of fibers and the second plurality of fibers remaining bonded to the first cap substrate. The method further includes placing a second cap substrate such that the plurality of fibers and the second plurality of fibers are between the first and the second cap substrates, and bonding the second cap substrate to the first cap substrate. The step of bonding includes applying a first bonding agent and at least partially curing the first bonding agent. One of the base substrate and the cap substrate are substantially transparent. The method further includes forming a trench on the first cap substrate prior to placing the cap substrate such that the fiber is between the base substrate and the first cap substrate, the trench of the first cap substrate being substantially aligned with the groove of the base substrate such that the fiber is located at least partially within the trench of the first cap substrate.

In another aspect, the invention provides an apparatus including a pair of substrates, a fiber sandwiched between the substrates, and a molded material holding the fiber in a predetermined alignment with respect to a pattern preformed in the molded material.

Variations of this aspect of the invention may include one or more of the following features. One of the substrates is of fused silica. One of the substrates defines a receiving pattern that at least roughly corresponds to the pattern. The receiving pattern includes a trench. The molded material includes an epoxy. The apparatus includes a plurality of fibers, each being sandwiched between the substrates and held by the molded material in a predetermined alignment with respect to the pattern. The apparatus is in combination with an external component, the substrates and the external component having substantially matching coefficients of thermal expansion. The apparatus is in combination with an external component, the substrates, the molded material and the external component having substantially matching coefficients of thermal expansion. The pattern preformed in the molded material includes a groove.

Advantages of the invention may include one or more of the following. The invention provides methods of manufacturing of high precision fiber arrays using materials having a coefficient of thermal expansion (“CTE”) that more closely matches the CTE of other optical components in an optical/mechanical assembly than does silicon. The invention also provides for the use of optically transparent materials for chips, which can be beneficial in some applications that rely on assembly techniques utilizing UV cured adhesives. Furthermore, the inventive methods are easily extendible to the manufacturing of 2-D fiber arrays.

Other features, objects, and advantages of the invention will be apparent from the following description and drawings, and from the claims.

### DESCRIPTION OF DRAWINGS

FIG. 1 is a schematic cross-sectional view of a base substrate with fiber aligning grooves;

FIG. 2 is a schematic cross-sectional view of fibers aligned within the grooves of the base substrate of FIG. 1;

FIG. 3 is a schematic cross-sectional view of a first cap substrate being lowered toward the base substrate and aligned fibers of FIG. 2 to position the aligned fibers between the base and the first cap substrates;

FIG. 4 is a schematic cross-sectional view of the first cap substrate of FIG. 3 in its fully lowered position with the aligned fibers positioned between the base and the first cap substrates;

FIG. 5 is a schematic cross-sectional view of the first cap substrate being raised away from the base substrate with the aligned fibers bonded to the first cap substrate and remaining in their aligned positions relative to one another;

FIG. 6 is a schematic cross-sectional view of a second cap substrate bonded to the first cap substrate so that the bonded, aligned fibers of the first cap substrate are positioned between the first and the second cap substrates;

FIG. 7 is a schematic cross-sectional view of a first cap substrate having bonded, aligned fibers, e.g., such as that of FIG. 5, being lowered toward a base substrate having fibers aligned in grooves thereof, e.g., such as that of FIG. 2, such that the bonded fibers of the first cap substrate and the aligned fibers of the base substrate are positioned between the first cap substrate and the base substrate;

FIG. 8 is a schematic cross-sectional view of a bonding agent being applied between the first cap substrate and base substrate of FIG. 7;

FIG. 9 is a schematic cross-sectional view of the first cap substrate of FIG. 8 having two rows of bonded, aligned fibers being lowered toward a base substrate having fibers aligned in grooves thereof, e.g., such as that of FIG. 2, such that the bonded fibers of the first cap substrate and the aligned fibers of the base substrate are positioned between the first cap and the base substrate;

FIG. 10 is a schematic cross-sectional view of the first cap substrate of FIG. 9 having three rows of bonded, aligned fibers and being bonded to a second cap substrate such that the fibers are positioned between the first and the second cap substrates;

FIG. 11 is a schematic cross-sectional view of a base substrate defining a plurality of peaks being lowered onto a first cap substrate;

FIG. 12 is a schematic cross-sectional view of the base substrate and the first cap substrate of FIG. 11 in contact with one another and having a bonding agent applied therebetween;

FIG. 13 is a schematic cross-sectional view of a layer of bonding agent that forms a plurality of spaced-apart, fiber aligning grooves on one surface of the first cap substrate of FIG. 12;

FIG. 14 is a schematic cross-sectional view of the first cap substrate of FIG. 13 having a plurality of fibers aligned within the grooves of the bonding agent and a second cap substrate being bonded to the first cap substrate so that the fibers are positioned between the first and the second cap substrates;

FIG. 15 is a schematic cross-sectional view of a fist cap substrate having a groove-forming layer of bonding agent similar to that of FIG. 13;

FIG. 16 is a schematic cross-sectional view of the first cap substrate of FIG. 15 having a plurality of aligned fibers and a bonded second cap substrate similar to that of FIG. 14;

FIG. 17 is a schematic cross-sectional view of a base substrate having a plurality of fibers aligned in grooves thereof, a first cap substrate defining grooves for approximately receiving the aligned fibers therein, the cap substrate being positioned so that the fibers are located between the base substrate and the cap substrate, and a layer of a bonding agent being applied between the first cap substrate and the base substrate;

FIG. 18 is a schematic cross-sectional view of the first cap substrate of FIG. 17 being raised away from the base substrate, the aligned fibers remaining bonded to the first cap substrate;

FIG. 19 is a schematic cross-sectional view of the first cap substrate with bonded, aligned fibers of FIG. 18 being bonded to a second cap substrate such that the fibers are positioned between the first and the second cap substrates;

FIG. 20 is a view similar to that of FIG. 19, but the second cap substrate having preformed grooves for approximately receiving the aligned fibers that have been previously bonded to the first substrate;

FIG. 21 is a schematic, isometric view of a fiber array of the invention; and

FIG. 22 is a diagrammatic view of the fiber array of FIG. 21 in use.

### DETAILED DESCRIPTION

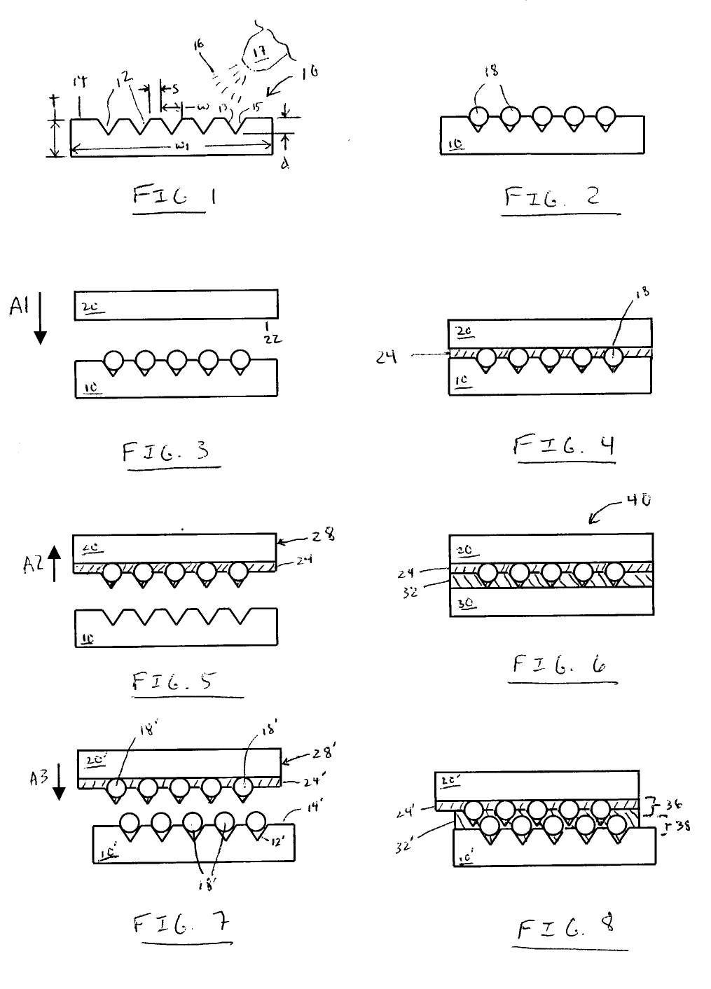

Referring to FIG. 1, a base substrate 10 defines a series of parallel spaced apart grooves 12 in its upper surface 14. Grooves 12 are formed in base substrate 10 by, e.g., etching. In one example, base substrate 10 is of silicon and grooves 12 are formed by etching, e.g., anisotropically. Using such a technique, the formation of the size, shape and spacing of the grooves can be tightly controlled. In one embodiment, each groove 12 has a width, w, of approximately 213 microns and a depth, d, of approximately 150 microns, and the lateral spacing, s, between grooves is approximately 250 microns. In this embodiment, the base substrate has a thickness, t, of approximately 500 microns, a width, wl, of approximately 5 mm, and a length (not shown) of approximately 7 mm.

To aid in the use of base substrate 10 as a replication tool, in the manner described in detail below, surface 14 and grooves 12 are treated with a release agent 16, e.g., a release agent commercially available from United Chemical Technologies as part number PS 216.

Referring now also to FIG. 2, grooves 12 are suited for receiving and aligning fibers 18, such as optical fibers, in a predetermined fashion. As illustrated, one fiber 18 is placed at least partially within each groove 12 such that the groove surfaces 13, 15 act to center the fibers 18 within their respective grooves. In one example, where the grooves have the dimensions mentioned in the specific embodiment mentioned above, each fiber 18 has an outer diameter of 125 um.

Referring now also to FIGS. 3 and 4, a first cap substrate 20 is moved (direction of arrow A1, FIG. 3), e.g., downwardly, to a position adjacent base substrate 10 (FIG. 4) so that fibers 18 are positioned between one surface 22 of first cap substrate 20 and base substrate 10. Typically, the cap substrate is of a material having a coefficient of thermal expansion that is particularly suitable for the application in which the fiber array is intended for use. For example, the selected material for the first cap substrate will have a coefficient of thermal expansion that is similar to that of one or more of the components to which the fiber array will be attached. In one embodiment, the cap substrate is of fused silica. In other examples, the first cap substrate is of an optical glass, which is selected to match the material that is used in a lens array to which the fiber array is intended to be connected. In still other examples, the first cap substrate is of molded plastic.

Once the first cap substrate has been positioned adjacent the base substrate, a bonding agent 24 is introduced between the first cap substrate and the base substrate to substantially fill any gaps therebetween and to thereby substantially encapsulate the aligned fibers 18. The bonding agent 24 is then cured. Any bonding agent that can be cured or otherwise set to effectively hold the fibers in place and in their aligned positions is suitable. In one example, the bonding agent 24 is an epoxy resin available from Electronic Materials, Inc. as part number 3553-UTF-HM and the curing process includes exposing the bonding agent to UV light for 20 seconds and then subjecting the bonding agent to 120° C. for 30 minutes. Other suitable examples of bonding agents/techniques include adhesives, eutectic, and quartz fusion bonding.

While in the illustrated embodiments the cap substrates are shown to be brought into contact with the fibers, such contact is not necessary. For example, a jig or other fixture could be used to position the cap substrate some distance from the base substrate while the bonding agent is introduced.

Referring now also to FIG. 5, first cap substrate 20 is removed, e.g., lifted in the direction of arrow A2, from base substrate 10. Notably, the cured bonding agent 24′ retains the shape of the gap(s) that it had filled between the first cap substrate and the base substrate and also acts to retain the aligned fibers in their relative positions. Cured bonding agent 24 is substantially permanently bonded to first cap substrate 20 and remains with cap 20 as it is removed from base substrate 10. Due, in part, to the action of release agent 16, base substrate 10 is not bonded to cured bonding agent 24′ and the assembly 28—including first cap substrate 20, cured bonding agent 24′ and the at least partially encapsulated fibers 18—is removed as a unit from base substrate 10.

Referring now also to FIG. 6, assembly 28 is placed adjacent a second cap substrate 30 such that the fibers 18 are positioned between the first and the second cap substrates. Typically, the second cap substrate is of the same material (or, at least a similar material) to that of the first cap substrate so as to reduce any effects associated with dissimilar coefficients of thermal expansion, as discussed above. Subsequent to positioning second cap substrate 30 relative to assembly 28, a second bonding agent 32 is introduced to the gap between the first and second cap substrates. The second bonding agent 32 can be the same as or different than the first bonding agent. In one example, the first and second bonding agents are the same, the second layer being cured in a manner similar to the first, as described above. In another example, the bonding agents are different, the first being a UV curable epoxy and the second being a thermally cured epoxy. This second example advantageously allows the fibers to be initially tacked to the first cap substrate by a relatively brief exposure to UV energy and then to be subsequently fully cured simultaneously with the second bonding agent, e.g., by exposure to an elevated temperature for a given time.

The resulting fiber array 40 (FIG. 6) includes fibers that have been aligned with the precision of the base substrate, e.g., an etched silicon chip. However, the aligned fibers are housed within selected materials, i.e., the first and second cap substrates and bonding agents, that have desired physical properties, such as coefficients of thermal expansion that match those of items to which the fiber array will connect.

Referring now also to FIGS. 7-10, the techniques described above with reference to FIGS. 1-6 can be expanded to produce two-dimensional arrays of fibers. The expanded technique includes forming an assembly 28′, similar to the assembly 28 described above with reference to FIG. 5, i.e., including a first cap substrate 20′ and aligned, bonded fibers 18′. Abase substrate 10′ having formed grooves 12′ on a surface 14′ is treated with a release agent and fibers are positioned at least partially within the grooves. In one example, base substrate 10′ is the same base substrate that was used to form assembly 28′ (i.e., assembly 28′ being formed in a manner similar to that of assembly 28 described above with reference to FIGS. 1-5, which was formed by use of base substrate 10). In another example, base substrate 10′ is different than the base substrate used to form assembly 28, e.g., having grooves formed in the same or a different pattern than the grooves of the base substrate from which assembly 28′ was made, or being of a different material than the base substrate from which assembly 28′ was made). In any event, assembly 28′ is positioned adjacent the aligned fibers of base substrate 10′, e.g., by lowering assembly 30′ in the direction of arrow A3.

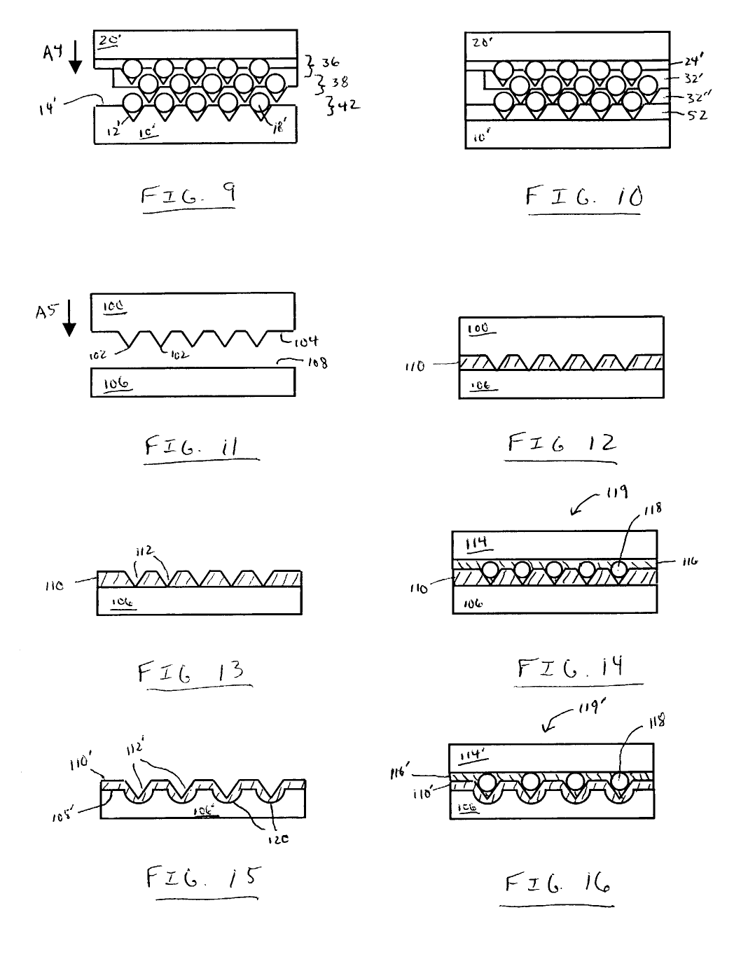

A second bonding agent 32′ is then introduced to the gap(s) formed between the at least partially cured first bonding agent 24′ and the directly adjacent grooved surface 14′ of base substrate 10′ (FIG. 8). Second bonding agent 32′ is then cured, e.g., in any of the manners described above, and first cap substrate 20′ with its now substantially permanently bonded first and second rows 36, 38, respectively, of aligned fibers 18 is then removed, e.g., lifted away, from base substrate 10′.

This same basic process can be repeated to add one or more additional rows to the two-dimensional array of fibers being produced. As illustrated in FIG. 9, a third row 42 is added by: recoating grooved surface 14′ of base substrate 10′; reloading grooves 12′ with fibers; positioning, e.g., by lowering in the direction of arrow A4, first cap substrate 20′—with its previously bonded first and second rows 36, 38 of aligned fibers 16—adjacent base substrate 10′; introducing a third bonding agent 32″ to the gap(s) formed between the at least partially cured second bonding agent 32′ and grooved surface 14′; at least partially curing third bonding agent 32″; and then removing the first cap substrate with its first, second and third rows 36, 38 and 42, of bonded, aligned fibers from base substrate 10′. Finally, as illustrated in FIG. 10, the first cap substrate 20′, with its bonded, aligned rows of fibers, is bonded to a second cap substrate 30′ with bonding agent 52′ to complete the two-dimensional array 50′.

Many of the principles described above can be adapted to provide other techniques for producing fiber arrays. For example, as illustrated in FIGS. 11-14, abase substrate 100, e.g., a silicon chip, defining a plurality of peaks 102 on a first surface 104 is formed in much the same manner as base substrates 10′, described above, e.g., by etching techniques. After application of a release agent to peaked surface 104, base substrate 100 is positioned, e.g., lowered in the direction of arrow A5, so that peaks 102 are directly adjacent a first cap substrate 106. A first bonding agent 110 is then introduced to the gap(s) formed between peaked surface 104 and first surface 108 of first cap substrate 106 (FIG. 12). First bonding agent 110 is then cured (at least partially) and then base substrate 100 is removed from first cap substrate 106. First bonding agent 110 remains substantially permanently bonded to first cap substrate 106 and forms a series of grooves 112 having substantially the same shape as peaks 102 of base substrate 100 (FIG. 13). As illustrated in FIG. 14, grooves 112 can be used to align fibers 16 in much the same manner as base substrates 10′ described above with reference to FIGS. 1-10. However, unlike base substrates 10′, the formed grooves of first cap 106 are of a cured epoxy or other bonding agent, which has been selected to have desirable material properties, e.g., a coefficient of thermal expansion similar to that of mating components. As further illustrated in FIG. 14, a second cap substrate 114 can be bonded, e.g., by second bonding agent 116, such that aligned fibers 18 are sandwiched between the first and second cap substrates to form fiber array 119.

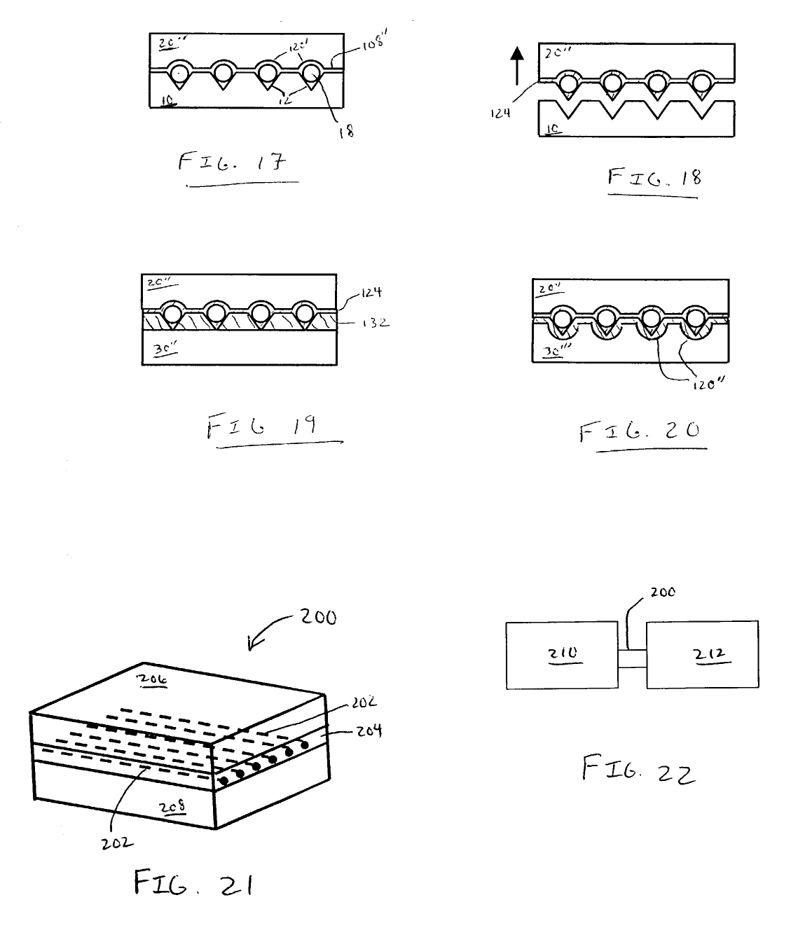

Referring now to FIGS. 15 and 16, the replication of grooves on a first cap substrate, as described above with reference to FIGS. 11-14, can also be performed on a first cap substrate that has preformed trenches for receiving such grooves. First cap substrate 106′ is provided having preformed trenches 120, which have been etched, molded, machined, or otherwise provided on a first surface 108′. Once again, first cap substrate 106′ is of a material having desirable material properties, e.g., a coefficient of thermal expansion that is similar to that of the components with which the fiber array to be formed will mate. As a general result of the material choice and limitations of forming techniques on such materials, the level of precision with which trenches 120 are formed on base substrate 106′ is less than the precision with which peaks 102 have been formed on base substrate 100 (FIG. 11). However, trenches 120 are formed to at least roughly coincide with peaks 102 of base substrate 100.

After positioning base substrate 100 relative to first cap substrate 106′ and applying and curing a first bonding agent 110′, in a manner similar to that described above with reference to FIGS. 12 and 13, base substrate 100 is removed. As a result, first bonding agent 110′ remains substantially permanently bonded to cap substrate 106′ and forms a series of grooves 112′, each of which is substantially positioned within a coinciding, preformed trench 120. By preforming trenches 120 in first cap substrate 106′, the amount of first bonding agent 110′ necessary for the groove replication process is reduced. This, in turn, reduces the necessary cure time/energy required for first bonding agent 110′ and can also reduce any unwanted effects that might be introduced by the material properties, e.g., the coefficient of thermal expansion, of the bonding agent in the formed fiber array.

In a manner similar to that described above with respect to FIG. 14, fibers 18 can be aligned within the replicated grooves of first cap substrate 106′ and a second cap substrate can be bonded to form a fiber array, as illustrated in FIG. 16.

As illustrated in FIGS. 17-20, similar principles to those discussed above can be employed to form a fiber array having a cap substrate with pre-formed trenches, but without pre-formed, replicated grooves. This technique uses base substrate 10, i.e., a base substrate identical to that discussed above with reference to FIGS. 1-6. First cap substrate 20″ has preformed trenches 120′, which have been etched, molded, machined, or otherwise provided on a first surface 108″. Once again, first cap substrate 20″ is of a material having desirable material properties, e.g., a coefficient of thermal expansion that is similar to that of the components with which the fiber array to be formed will mate. As a general result of the material choice and limitations of forming techniques on such materials, the level of precision with which trenches 120′ are formed on first cap substrate 20″ is less than the precision with which grooves 12 have been formed on base substrate 10 (FIG. 1). However, trenches 120′ are formed to at least roughly coincide with grooves 12 of base substrate 10.

In a manner similar to that discussed in detail above with reference to FIGS. 2-4, fibers 18 are aligned within grooves 12 of base substrate 10. First cap substrate 20″ is then positioned directly adjacent base substrate 10 with fibers 18 positioned between first cap substrate 20″ and base substrate 10 and trenches 120′ of first cap substrate 20″ substantially aligned with the fibers 18 and their respective aligning grooves 12. A first bonding agent 124 is introduced to the gap(s) formed between the first cap and base substrates and is then at least partially cured. First cap substrate 20″ is then removed from base substrate 10 with the aligned fibers 18 remaining bonded to and positioned substantially within trenches 120′ of first cap substrate 20″ (FIG. 18).

Subsequently, a second cap substrate 30″ is bonded (by a second bonding agent 132) to the first cap substrate 20″ with the aligned fibers sandwiched therebetween (FIG. 19). Alternatively, in one embodiment (FIG. 20), second cap substrate 30′″ has pre-formed trenches 120″ that at least roughly coincide with those of first cap substrate 20″. In this manner, the amount of bonding agent necessary to form the fiber array is reduced.

FIG. 21 schematically illustrates a fiber array 200 made using one or more of the above described techniques. Fiber array 200 includes a series of fibers 202 held by one or more layers of a bonding agent 204 between a first cap substrate 206 and a second cap substrate 208. The positions in which fibers 202 are held relative to one another are substantially identical to predetermined positions in which the fibers were initially placed in a pattern defined by a base substrate, e.g., a pattern that had been etched into a base substrate of silicon. While the fibers 202 in fiber array 200 are arranged parallel to one another in a linear fashion, other patterns can also be achieved.

In one exemplary use (illustrated in FIG. 22), fiber array 200 extends (and provides communication through fibers 202) between a first and a second component 210, 212. In this example, the material(s) of first and second cap substrates 206, 208, bonding agent 204 and first and second components 210, 212 is/are selected to have substantially similar coefficients of thermal expansion. Thus, any shrinkage or expansion effects of a temperature change in the environment of use will have a similarly effect each of fiber array 200 and first and second components 210 and alignment of fibers 202 and their junctions with first and second components 210, 212 will remain substantially unaffected.

A number of embodiments of the invention have been described. Nevertheless, it will be understood that various modifications may be made without departing from the spirit and scope of the invention. For example, the techniques for manufacturing two-dimensional arrays, described above with reference to FIGS. 7-10, can be combined with the bonding agent reducing techniques of pre-forming trenches in the first and/or second cap substrates, as described above with reference to FIGS. 15-20. Accordingly, other embodiments are within the scope of the following claims.

What is claimed is:

1. A method comprising
using a base substrate to form an alignment pattern,
holding a fiber fixed with reference to the pattern,
while the fiber is held fixed, bonding a cap to the fiber, the cap being of a material having a different coefficient of thermal expansion than the base substrate.

2. The method of claim 1 in which the fiber is an optical fiber.

3. The method of claim 1 also including removing the fiber and the cap as a unit from the pattern.

4. The method of claim 1 in which the alignment pattern is formed in the substrate.

5. The method of claim 1 in which the alignment pattern is formed in a material by molding the material against the pattern.

6. The method of claim 1 in which two or more fibers are held fixed with reference to the pattern and the cap is bonded to all of the fibers.

7. The method of claim 1 in which the pattern comprises grooves.

8. The method of claim 1 in which the fiber is held fixed with reference to the pattern by contact with the pattern.

9. The method of claim 1 also including bonding a second cap to the fiber.

10. The method of claim 9 in which the second cap forms a receiving pattern arranged to at least roughly correspond to the alignment pattern.

11. The method of claim 10 in which the receiving pattern comprises trenches.

12. The method of claim 1 in which the cap forms a receiving pattern arranged to at least roughly correspond to the alignment pattern.

13. The method of claim 10 in which the receiving pattern comprises trenches.

14. The method of claim 1 also including coupling the cap and bonded fiber to another component that has a coefficient of thermal expansion matched to the coefficient of thermal expansion of the cap.

15. The method of claim 1 in which the base substrate is of silicon.

16. The method of claim 15 in which the alignment pattern is etched in the base substrate.

17. The method of claim 1 in which the cap substrate is of fused silica.

18. A method comprising:
etching a groove in a base substrate;
positioning a fiber at least partially within the groove;
placing a first cap substrate adjacent the base substrate such that the fiber is between the base substrate and the cap substrate; and
bonding the fiber to the cap substrate.

19. The method of claim 18 further comprising separating the first cap substrate from the base substrate with the fiber remaining bonded to the first cap substrate.

20. The method of claim 19 further comprising placing a second cap substrate adjacent the first cap substrate with the fiber positioned between the first and the second cap substrates.

21. The method of claim 20 further comprising bonding the second cap substrate to the first cap substrate.

22. The method of claim 18, further comprising coating the base substrate with a release agent.

23. The method of claim 18, wherein the base substrate comprises silicon.

24. The method of claim 1, wherein the first cap substrate comprises fused silica.

25. The method of claim 1, wherein the step of etching includes anisotropic etching.

26. The method of claim 1, wherein the step of etching includes forming a plurality of grooves in the base substrate.

27. The method of claim 26, further comprising positioning a first plurality of fibers such that each is at least partially within one of said plurality of grooves in the base substrate.

28. The method of claim 27, further comprising bonding each of said first plurality of fibers to the first cap substrate.

29. The method of claim 28, further comprising separating the cap substrate from the base substrate with the first plurality of fibers remaining bonded to the first cap substrate.

30. The method of claim 29, further comprising:
positioning a second plurality of fibers such that each is at least partially within one of said plurality of grooves in the base substrate;
placing said first cap substrate with the first plurality of fibers adjacent the base substrate such that the second plurality of fibers is between the first cap substrate and the second cap substrate; and
bonding the second plurality of fibers to the first cap substrate.

31. The method of claim 30, wherein the second fibers is bonded to the first cap substrate in a position directly adjacent the first plurality of fibers.

32. The method of claim 30, further comprising separating the first cap substrate from the base substrate with the first and the second pluralities of fibers remaining bonded to the first cap substrate.

33. The method of claim 32 further comprising:
placing a second cap substrate such that the first and the second pluralities of fibers are between the first and the second cap substrates; and
bonding the second cap substrate to the first cap substrate.

34. The method of claim 18, wherein the step of bonding includes applying and at least partially curing a first bonding agent and at least partially curing the first bonding agent.

35. The method of claim 18, wherein one of the base substrate and the cap substrate are substantially transparent.

36. The method of claim 18 further comprising forming a trench on the first cap substrate prior to placing the cap substrate such that the fiber is between the base substrate and the first cap substrate, the trench of the first cap substrate being substantially aligned with the groove of the base substrate such that the fiber is located at least partially within the trench of the first cap substrate.

37. An apparatus comprising:
a pair of substrates;
a fiber sandwiched between the substrates; and
a molded material holding the fiber in a predetermined alignment with respect to a pattern preformed in the molded material.

38. The apparatus of claim 37 wherein one of the substrates is of fused silica.

39. The apparatus of claim 37 wherein one of said substrates defines a receiving pattern that at least roughly corresponds to said pattern.

40. The apparatus of claim 39 wherein the receiving pattern comprises a trench.

41. The apparatus of claim 37 wherein the molded material comprises an epoxy.

42. The apparatus of claim 37 including a plurality of fibers, each being sandwiched between the substrates and held by the molded material in a predetermined alignment with respect to the pattern.

43. The apparatus of claim 37 in combination with an external component, the substrates and the external component having substantially matching coefficients of thermal expansion.

44. The apparatus of claim 37 in combination with an external component, the substrates, the molded material and the external component having substantially matching coefficients of thermal expansion.

45. The apparatus of claim 37 wherein the pattern preformed in the molded material comprises a groove.
